(19) United States
(12) Patent Application Publication
(10) Pub. No.: US 2013/0271247 A1
(43) Pub. Date: Oct. 17, 2013

(54) Magnetic Device For Removeably Attaching Objects To Metallic Surfaces And Methods Of Use

(71) Applicant: Roger Apostolico, Orlando, FL (US)

(72) Inventor: Roger Apostolico, Orlando, FL (US)

(21) Appl. No.: 13/446,039

(22) Filed: Apr. 13, 2012

(51) Int. Cl. H01F 7/02

(52) U.S. Cl. CPC H01F 7/0252
USPC 335/286

(57) ABSTRACT

The present invention provides a new and useful magnetic device for removeably attaching objects to metallic surfaces and method of use. It comprises a magnet enclosed in an external casing and is believed to be useful by offering a device with multiple attachment points, including a cleat and loop, and is removeably attached to metallic surfaces thereby allowing the user to securely fasten objects in a non-destructive manner, without marring or damaging the target surface. The device contemplated by this invention is also reusable, can be made in a variety of shapes, sizes and of different magnetic strengths. Finally, this device is resilient and useable in outdoor or high moisture environments, including underwater.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### TECHNICAL FIELD

The present invention is in the technical field of magnetic devices. More particularly, the present invention is in the technical field of removeably attached magnetic devices. More particularly, the present invention is in the technical field of removeably attached magnetic devices for securing external objects to metallic surfaces.

### BACKGROUND OF THE INVENTION

The practice of fastening objects together for a particular purpose or task is ubiquitous in modern life. Depending on the task, the objects are secured in a variety of ways, and using varied methods. These methods range in size, permanency, and strength. For example, heavy vehicles are secured to multi-ton transport trucks by many large fastening winches, while delicate sheets of paper are fastened by a single small staple. Regardless the basic need for fastening and securing objects together is essentially the same. Many tasks simply cannot be completed without some attaching functionality.

The concept of organizing things by means of attaching is easily understood and practiced. When it comes to attaching devices that are easily used by an individual, these typically range in the realm of staples, tapes, strings, tacks and the like. Whole industries and markets have arisen around everyday home and office use devices.

Some of these attaching devices like tacks and staples are destructive when implemented—as they must perforate the objects being fastened. Picture a staple in a stack of papers or a nail in a wall. When removed the subject object or surface is left damaged.

Temporary or non-destructive attaching means are more modern, but quickly becoming equally ubiquitous. They include releasable adhesive strips, tapes, and magnets. The company 3M is known worldwide for their innovation in temporary adhesive products. However, many of these temporary attaching means are not reusable. Most of them are not resilient in the outdoors or environments with high moisture or humidity.

In the applicant's experience there is a need for a magnetic device for removeably attaching objects to metallic surfaces which: i) is easily attached and removed, ii) firmly secures the objects to the surface, iii) offers multiple attachment points, including a cleat, loop and bottom surface, iv) functions non-destructively, without marring or damaging the target surface, v) is reusable, vi) can be made in a variety of shapes, sizes and strengths, and vii) is resilient in outdoor or high moisture environments. The device of the present invention is believed to accomplish all of the foregoing objectives.

### SUMMARY OF THE INVENTION

The present invention provides a new and useful magnetic device for removeably attaching objects to metallic surfaces and method of use. This invention is believed to be useful by offering a device with multiple attachment points, including a cleat and loop, and is removeably attached to metallic surfaces thereby allowing the user to securely fasten objects in a non-destructive manner, without marring or damaging the target surface. The device contemplated by this invention is also reusable, can be made in a variety of shapes, sizes and of different magnetic strengths. Finally, this device is resilient and useable in outdoor or high moisture environments, including underwater.

Current comparable devices are essentially single hooks with magnets attached thereon. These devices do not offer multiple points of attachment, and are usually made of metal, which can corrode or rust. Further the magnets included in these devices are not rare earth magnets.

In one of its basic embodiments the present invention comprises a rare earth magnet surrounded by an exterior casing. The exterior casing of which is molded in an essentially cylindrical shape with a top surface, a bottom surface and at least one side surface. The external casing also features a receiving loop and cleat extending therefrom. The receiving loop is located along the top surface of the device and is formed from a raised portion of the top surface of the exterior casing. An aperture or hole is defined by the lower edge of the loop and the top surface of the exterior casing. The cleat of the device extends radially from the device and is formed from an outward extension of the top surface and side surface of the device.

When the device is in use, the user magnetically attaches the device to a target surface. dictated by the task to be accomplished. For example, if one desires to secure items in the back of a pick-up truck, the user will affix the device to the interior metal surfaces of the bed of the truck. With the device now firmly affixed, the user can then pass fastening means like rope, string, hooks or ties through the receiving loop of the device. The user may also secure fastening means to the cleat of the device—for example she may hook the eye of a net, or a grommet on a tarp. The user then can implement multiple devices to continue to secure the items in the pickup bed until the task is satisfactorily complete.

Another point of attachment offered by the device is the magnetic bottom surface itself. One may secure an item like a sheet, tarp or papers to a metallic surface by simply placing the item between the target surface and the device. One can imagine use of this device to hold a paper on the interior of a school locker, or a police officer fixing a report to the hood of his patrol car on a windy day. This device can also be used to fasten items underwater; for example a thermometer in a tank, a diving schedule on a shark cage. The possibilities are endless and are limited only to the user's imagination.

Thus the present invention is believed to provide a new and useful screen device which: i) is easily attached and removed, ii) firmly secures the objects to the surface, iii) offers multiple attachment points, including a cleat, loop and bottom surface, iv) functions non-destructively, without marring or damaging the target surface, v) is reusable, vi) can be made in a variety of shapes, sizes and strengths, and vii) is resilient in outdoor or high moisture environments. The device of the present invention is believed to accomplish all of the foregoing objectives. The device of the present invention is believed to accomplish all of the foregoing objectives.

Further features and objectives of the present invention will become apparent from the following detailed descriptions and the accompanying drawings.

### BRIEF DESCRIPTION OF THE DRAWINGS

FIG. 1 is a top view of the device according to the present invention;

FIG. 2 is a perspective view of the bottom of the device according to the present invention and shows the rare earth magnet inserted into the exterior casing;

FIG. 3 is a perspective side view of the device according to the present invention; and

FIG. 4 is a perspective side view of the present invention being used in its environment and receiving a rope through the aperture of the device.

### DETAILED DESCRIPTION OF THE INVENTION

As described above, the present invention provides a new and useful magnetic device for removeably attaching objects to metallic surfaces and method of use. This invention is believed to be useful by offering a device with multiple attachment points, including a cleat and loop, and is removeably attached to metallic surfaces thereby allowing the user to securely fasten objects in a non-destructive manner, without marring or damaging the target surface. The device contemplated by this invention is also reusable, can be made in a variety of shapes, sizes and of different magnetic strengths. Finally, this device is resilient and useable in outdoor or high moisture environments, including underwater. The following description and accompanying drawings disclose at least one version of such a device.

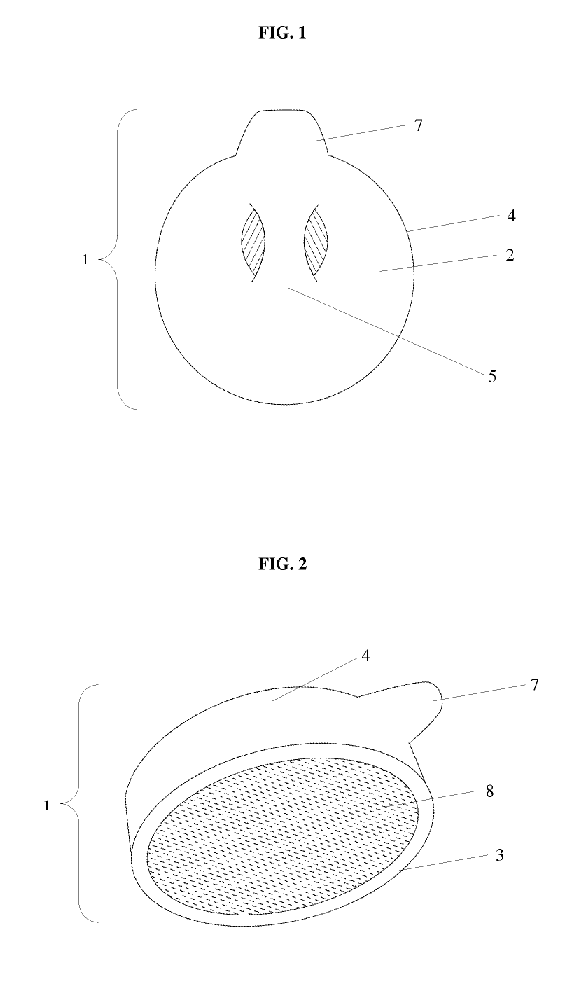

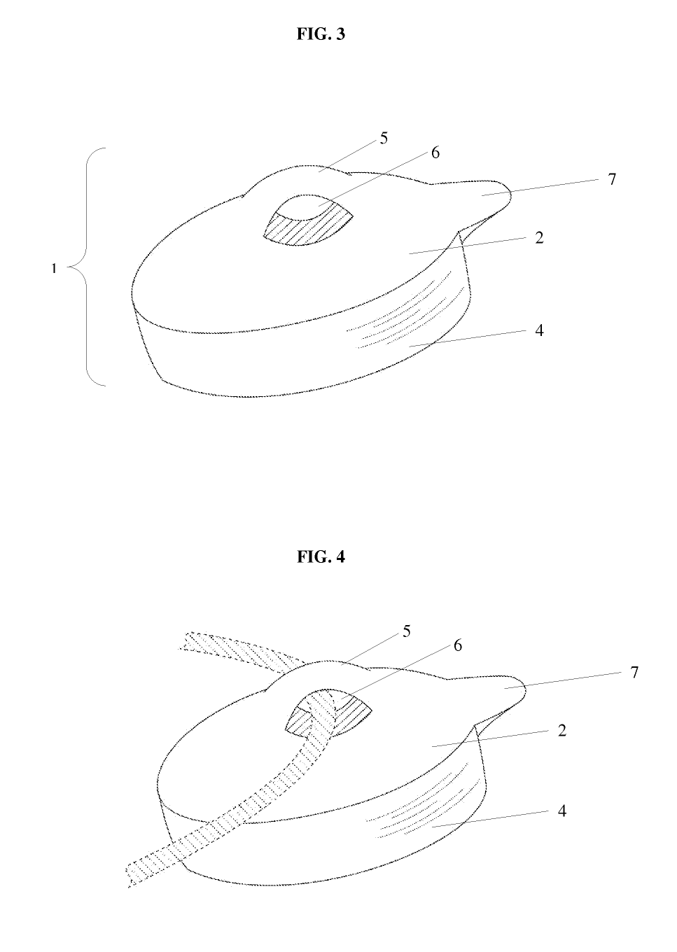

Referring now to the invention in more detail, in FIG. 1, FIG. 2, FIG. 3 and FIG. 4, there is a magnetic device for removeably attaching objects to metallic surfaces. The device comprises an exterior casing 1, said exterior casing 1 having an essentially cylindrical shape with a top surface 2, a bottom surface 3, and at least one side surface 4. The exterior casing 1 is composed of strong, durable, non-degrading, and non-marring material such as pvc or plastic. A receiving loop 5 is located along the top surface 2 of the device and is formed form a raised portion of the top surface 2 of the exterior casing 1. The receiving loop 5 defines an aperture 6 between the top surface 2 of the magnetic device and the receiving loop 5. A cleat 7 extends radially from the device and is formed from an outward extension of the top surface 2 and side surface 4 of the device. A magnet 8, which can be a rare earth magnet, is permanently attached an housed within the exterior casing 1 of the device.

The dimensions of the device can be any size and the magnet can vary in strength from embodiment to embodiment—as dictated by the tasks for which it is intended. Securing heavier items to the interior of a pickup truck may warrant a device what's exterior case 1 is cast in a large dimension. The larger dimension will allow the device to house a stronger magnet 8 and offer larger or a plurality of attaching points, receiving loops 5 and cleats 7. For small tasks, like attaching a calendar to the inside of a school locker, a smaller exterior case 1 and weaker magnet 8 may be used. It is envisioned that one embodiment will have a diameter of at least four inches, while another may be less than four inches in diameter.

One embodiment of the invention wholly encloses the magnet 8 within the exterior case 1, thereby creating a waterproof seal to combat corrosion and allow use in moist environments, including underwater.

Another embodiment of the invention further comprises a pad made of non-abrasive material such as felt attached to the bottom surface of the exterior casing 1.

Another embodiment of the invention further comprises a decorative element printed or molded onto the external casing 1.

In FIG. 4, the device is shown in use with a fastening means, in this case a rope, secured through the aperture 6 of the external casing 1.

To use the device, the user selects a metallic surface as dictated by the task to be accomplished. The user then attaches at least one magnetic device to the metallic surface. A fastening means such as rope, net or ties, is employed by the user to secure an external object to an attaching point on the device. These attaching points include the cleat 7, the aperture 6 and the bottoms surface 3 of the device. Once the task is complete, the user unfastens the external object from any magnetic devices after use, and removes the magnetic devices from the metallic surface for storage. It is envisioned that the user may utilize or pull on the cleat 7 as a point of action or lever arm to more easily remove the device from the metallic surface; this is not a necessary step for use of the present invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A magnetic device for removeably attaching objects to metallic surfaces comprising:
a) an exterior casing,
said exterior casing having an essentially cylindrical shape with a top surface, a bottom surface and at least one side surface,
said exterior casing is made of a strong, durable, non-degrading, and non-marring material such as pvc or plastic;
b) a receiving loop,
said receiving loop is located along the top surface of the device and is formed from a raised portion of the top surface of the exterior casing,
said receiving loop defining an aperture between the top surface of the magnetic device and the receiving loop;
c) a cleat,
said cleat extending radially from the device and is formed from an outward extension of the top surface and side surface of the device; and
d) a rare earth magnet,
said rare earth magnet is permanently attached and housed within the exterior casing of the device.

2. A magnetic device comprising:
a) a casing that is molded in a three dimensional geometric shape having a bottom surface and a plurality of sides; and
b) a magnet permanently attached to the casing.

3. The device as in claim 2, wherein the casing further comprises at least one receiving loop located along the casing for the purposes of receiving rope, string, cable tie or other receiving means from the user.

4. The device as in claim 2, wherein the casing further comprises at least one cleat extending from the device in order to allow the user to attach an external object using fastening means to the device.

5. The device as in claim 2, wherein the magnet is a rare earth magnet.

6. The device as in claim 2, wherein the casing is made of a strong, durable, non-degrading, and non-marring material such as pvc or plastic.

7. The device as in claim 2, wherein the magnet is partially enclosed by the casing.

8. The device as in claim 2, wherein the magnet is wholly enclosed by the casing.

9. The device as in claim 1 or 2, further comprising a pad made of non-abrasive material, such as felt, attached to the bottom surface of the casing.

10. The device as in claim 1 or 2, wherein a decorative element is printed on the external casing.

11. A method of use for removeably attaching objects to metallic surfaces comprising:
a) selecting a metallic surface;
b) attaching at least one magnetic device to the metallic surface;
c) employing a fastening means to secure an external object to at least one magnetic device for a desired purpose, task, or time period;
d) unfastening the external object from any magnetic devices after use; and
e) removing the magnetic devices in use from the metallic surface.

12. The method of use as in claim 11, wherein the fastening means can be a rope, string, tie or other equivalent.
